(19) United States
(12) Patent Application Publication
(10) Pub. No.: US 2022/0258412 A1
(43) Pub. Date: Aug. 18, 2022

(54) METHOD FOR PRODUCING 3D MOLDED PARTS WITH VARIABLE TARGET PROPERTIES OF THE PRINTED IMAGE DOTS

(71) Applicant: Voxeljet AG, Friedberg (DE)

(72) Inventors: Christoph Scheck, Augsburg (DE); Lisa Brüller, Augsburg (DE); Wolfgang Mühlbauer, Augsburg (DE)

(21) Appl. No.: 17/627,729

(22) PCT Filed: Jul. 14, 2020
(86) PCT No.: PCT/DE2020/000153

§ 371 Date: Jan. 17, 2022

(30) Foreign Application Priority Data
Jul. 17, 2019 (DE) 102019 004955.1

(51) Int. Cl. B29C 64/165; B33Y 10/00; B29C 64/209

(52) U.S. Cl. CPC B29C 64/165; B33Y 10/00; B29K 2995/0046; B29K 2995/007; B29C 64/209

(57) ABSTRACT

A method for producing 3D moulded parts, wherein one or more building materials in the form of particles are applied in a defined layer to a building area by means of a coater (101), one or more absorbers or one or more liquids comprising one or more absorbers are selectively applied as printed image dots by means of a printhead (100), an energy input is performed by means of an energy source (108, 109), wherein the regions with selectively applied absorber are selectively solidified, the building area is lowered by the thickness of a layer or the coater is raised by the thickness of a layer, these steps are repeated until the desired 3D moulded part (103) is created, wherein the amount of absorber within a layer (301) per printed image dot is set to a predetermined value and wherein predetermined values that are different in two or more image dots can be set within a layer.

### CLAIM OF PRIORITY

This application is a national phase filing under 35 USC § 371 from PCT Patent Application serial number PCT/DE2020/000153 filed on Jul. 14, 2020 and claim priority therefrom. This application further claims priority to German Patent Application Number DE 102019004955.1 filed on Jul. 17, 2019. International Patent Application number PCT/DE2020/000153 and German Patent Application number DE 102019004955.1 are each incorporated herein by reference in its entirety.

### FIELD

The invention relates to a method for producing three-dimensional models with variable target properties by means of a layer construction technique.

### BACKGROUND

European Patent EP 0 431 924 B1 describes a process for producing three-dimensional objects based on computer data. In the process, a thin layer of particulate material is deposited on a platform and has a binder material selectively printed thereon by means of a print head. The particulate region with the binder printed thereon bonds and solidifies under the influence of the binder and, optionally, an additional hardener. Next, the platform is lowered by one layer thickness into a construction cylinder and provided with a new layer of particulate material, the latter also being printed on as described above. These steps are repeated until a certain desired height of the object is achieved. Thus, the printed and solidified regions form a three-dimensional object.

Upon completion, the object made of solidified particulate material is embedded in loose particulate material, from which it is subsequently freed. For this purpose, a suction device may be used, for example. This leaves the desired objects which then have to be freed from any residual powder, e.g. by brushing it off.

Other powder-based rapid prototyping processes (also referred to as layered construction of models or layer construction techniques), e.g. selective laser sintering or electron beam sintering, work in a similar manner, also applying loose particulate material layer by layer and selectively solidifying it with the help of a controlled physical source of radiation.

In the following, all these processes will be understood to be covered by the term “three-dimensional printing methods” or “3D printing methods”.

3D printing on the basis of pulverulent materials and introduction of liquid binders is the quickest method among the layer construction techniques.

This method allows various particulate materials, including polymeric materials, to be processed. However, it has the disadvantage that the particulate material bed cannot exceed a certain bulk density, which is usually 60% of the particle density. The strength of the desired parts significantly depends on the achieved density, however. Insofar it would be required here for high strength of the parts to add 40% or more by volume of the particulate material in the form of the liquid binder. This is not only a relatively time-consuming process due to the single-droplet input, but it also causes many process-related problems, which are given, for example, by the inevitable shrinkage of the liquid volume during solidification.

In another embodiment, which is known in the art as “high-speed sintering” (HIGH SPEED SINTERING), solidification of the particulate material is effected by input of infrared radiation. The particulate material is thus bonded physically by a fusing process. In this case, advantage is taken of the comparatively poor absorption of thermal radiation in colorless plastic materials. Said absorption can be increased multiple times by introducing an IR acceptor (absorber) into the plastic material. The IR radiation can be introduced by various means, e.g. a bar-shaped IR lamp, which is moved evenly over the construction field. Selectivity is achieved by the specific printing of the respective layer with an IR acceptor.

In the printed locations, the IR radiation thereby couples much better into the particulate material than in the unprinted regions. This results in selective heating within the layer beyond the melting point and, consequently, in selective solidification. This process is described, for instance, in EP1740367B1 and EP1648686B1.

The mechanical properties of the molded articles thus produced depend not only on the type of particulate material used as a basis, but also on the energy introduced during melting and thus on the melting temperature reached. In the high-speed sintering process, similar to the laser sintering process, it is therefore initially advantageous to minimize or compensate for fluctuations in heating, which lead to undesirable changes in the part properties of the molded articles produced. This allows not only process stability to be ensured, but also consistent quality to be reproduced isotropically with high repeatability.

The correlation of the change in mechanical variables with the amount of energy introduced during sintering has been studied many times and is part of numerous scientific publications, see e.g. dissertation by Andreas Wegner “Theorie über die Fortführung von Aufschmelzvorgängen als Grundvoraussetzung fûr eine robuste Prozessführung beim Laser-Sintern von Thermoplasten” (Theory on the continuation of fusing processes as a basic requirement for robust process control in laser sintering of thermoplastics), 2015.

One of the reasons discussed there for the variations in the mechanical variables of the molded articles produced is the dependence of the residual porosity on the amount of energy introduced. With regard to polyamide 12, which is established in additive manufacturing processes after the sintering process, low residual porosity is desired for the highest possible mechanical variables.

However, this is not the case for all types of materials. For instance, the demand for softer thermoplastic elastomers cannot be ignored. In this respect, a certain degree of residual porosity may be desirable in order to leave room for the generated article to change shape under the application of an external force.

It is therefore advantageous not only to vary the amount of energy introduced during the sintering process in order to achieve consistent material quality, but also to use said amount of energy to selectively adjust the material properties of the molded article produced in the process.

The energy selectively introduced into a layer can be influenced via various quantities. When coupling the sintering energy point by point according to an existing cutting pattern by means of a laser mirror system, as is common in the laser sintering process, the so-called Andrew number A_{Z} is an established quantity to estimate this energy in joules per mm² [Selective Laser Sintering Part Strength as a Function of Andrew Number, Scan Rate and Spot Size, John Williams, David Miller and Carl Deckard, 1996]:

$${A}_{Z} = \frac{{p}_{L S}}{{v}_{L S} \cdot {d}_{L S}} [ \frac{J}{m {m}^{2}} ]$$

$${A}_{z} : Andrew number$$

Here d_{LS} denotes the laser track spacing, p_{LS} is the laser power, and v_{LS} is the tracking speed. For the HIGH SPEED SINTERING process, a similar estimation can be made, e.g. according to the simple formula

$${A}_{Z} = \frac{{p}_{Si n} \cdot GL}{{v}_{Si n} \cdot {d}_{Dot}} [ \frac{J}{{mm}^{2}} ]$$

$${A}_{z} : Andrew number for HIGH SPEED SINTERING$$

Analogous to the laser sintering process, the movement of the sintering radiator vₛᵢₙ over the construction field represents a counterpart to the tracking speed of the laser v_{LS}, and the effective radiation power of the sintering unit pₛᵢₙ corresponds to the laser power p_{LS}. Instead of the track spacing d_{LS}, which in the case of the laser contributes reciprocally to the amount of energy, in the HIGH SPEED SINTERING process the dot density d_{dot} corresponding to the print resolution and the absorption coefficient GL of the printed spots can be assumed to contribute proportionally to a coupling constant. If the tracks which the laser draws in the particulate material when creating a layer of the molded article to be produced are closer together, this will lead to an increase in the coupled energy density. The same applies to increasing the degree of wetting of the powder surface with an IR acceptor. By increasing the absorber amount GL per area, the absorption coefficient of the IR radiation improves, leading to an increase in the efficiency of energy coupling during the sintering process.

By varying these, as well as the other variables, the melting temperature can now be directly influenced.

The well-known high speed sintering processes make use of the variation of the applied absorber amount to stabilize the printing process, see e.g. WO2016169615A1.

Since the IR acceptor is applied in the HIGH SPEED SINTERING process by means of inkjet printing modules, the density of the absorber per area can be adjusted by varying the dot density. This is possible because the inkjet technology is usually controlled via so-called bitmap patterns, which are based on a two-dimensional raster image process. Regarding the calculation of the point density, several established calculation methods are available. For the sake of simplicity, the term halftone process or dithering will be used in the following to refer to these processes. An illustration thereof is shown in FIG. 2.

However, this method of controlling absorber density has several disadvantages, including:

1) Reduction of the Achieved Accuracy in the Shape of the Articles Produced
In order to provide room for both energy increase and energy decrease, the absorber density range used should be between maximum and minimum dosing. Since a reduction in fluid density can only be achieved by omitting image dots to be printed, a checkerboard-like pattern is created, which leads to inaccuracies, especially at edge regions between the molded article and the loose particulate material. These inaccuracies not only result in a reduction of edge sharpness, but also lead to temperature gradients at the edges of the article. This leads to the adhesion of loose particulate material to the produced molded article and thus to a deterioration in dimensional accuracy.

2) Limited Area Adjustability
Further reduction of the dot density leads to areas wetted with absorber being so far apart that sintering them no longer results in a coherent area, see comparison in FIG. 2.

3) Low Surface Quality
The screening appears on the surfaces of the molded parts and creates a pattern that is disturbing to the eye and negatively affects the overall impression, regardless of the other properties of the part.

4) Second Printing Fluid Required
Conceivably, according to the prior art, a point-by-point variation of the effective energy density is also possible by using a second printing fluid whose function is to dissipate excess energy, as detailed, for example, in WO2016171724, “DETAILING AGENT FOR THREE-DIMENSIONAL (3D) PRINTING”. This also leads to the above mentioned phenomena and especially the reduced surface quality is already known in the industry.

5) Speed Disadvantage
Although it is conceivable to carry out multiple wetting steps, each directly followed by exposure of a single area, and thus to vary the distribution of the absorber within a dot to be applied without dithering, and thus to achieve the application of different amounts of energy without loss of detail, this considerably reduces the printing speed with each additional gray level and leads to sharply rising costs in the commercial operation of such a device.

It was therefore an object underlying the application to provide a 3D printing method using an absorber that at least partially reduces or substantially or completely avoids the disadvantages of the prior art.

Another object underlying the application was to provide a 3D printing method using an absorber with which improved edge sharpness can be achieved.

It was a further object underlying the application to provide a 3D printing method using an absorber, wherein a differentiated selection and adjustment of the absorber amount per image dot and of different absorber amounts in different image dots within a printing layer becomes possible and/or the absorber amount and the image dots can be varied in different parameters, such as area of the image dots, volume of the image dots, absorber concentration in the image dots. Also, in different image dots in a printing layer these parameters can be different and can be adjusted individually in each parameter.

The various aspects of the disclosure are suitable for reducing or completely avoiding various or all of the above disadvantages of the prior art.

### BRIEF SUMMARY OF THE DISCLOSURE

In a further aspect, the disclosure relates to a method for producing 3D molded parts, wherein one or more particulate construction materials are applied in a defined layer onto a construction field by means of a recoater, one or more absorbers or one or more liquids comprising one or more absorbers are selectively applied as printed image dots by means of a print head, energy is input by means of an energy source, the areas with selectively applied absorber selectively solidifying, the construction field is lowered by one layer thickness or the recoater is raised by one layer thickness, these steps are repeated until the desired 3D molded part is produced, characterized in that the amount of absorber within a layer per printed image dot is set to a predetermined value.

In a further aspect, the disclosure relates to a part produced by a 3D method having advantageous edge region properties and shape sharpness.

### BRIEF DESCRIPTION OF THE DRAWINGS

FIG. 1: This drawing outlines an example of a device for the production of molded articles by the high-speed sintering process with elementary components.

FIG. 2: This figure compares two methods of variable fluid dosing per area; 201 shows the prior art dithering method versus adjusting the absorber volume per image dot. In the prior art process, gaps in wetting 203, as opposed to 204, occur, which can lead to a reduction in parts quality. Even with small amounts of absorber per area, a closed area 206 is formed without an interference pattern with defects 205.

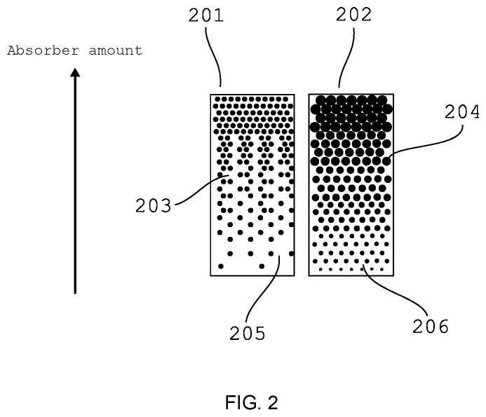

FIG. 3: This is a detailed view of the surface to be wetted, comparing conventional dosing technology 303 and new dispensing technology 304 (viewed along the X-Y plane). The reduction in edge sharpness in the prior art process can be clearly seen in the left half of the image at 305. The reason for this are so-called aliasing effects, which occur when the area to be wetted in the software representation does not correspond exactly to the physical structure of the fluid dosing device. In the new method, this can be taken into account by varying the fluid volume at the edge regions 306, which significantly increases the edge sharpness of the molded article to be produced.

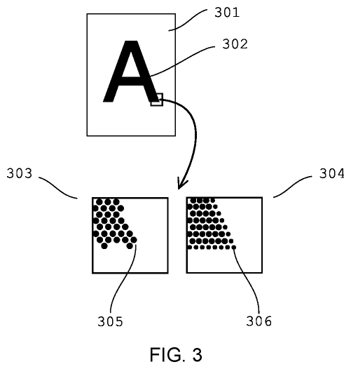

FIG. 4: This is a lateral detailed view of a corner of the molded article 402 to be created, juxtaposing both dosing processes 403 and 404 in a process of additive manufacturing technology according to the principle of powder-based layering (X-Z plane view). As can already be seen in the area in FIG. 3, the process leads to an improved surface quality of the object to be created in all three spatial dimensions, as evidenced by the gapless structure 406 in contrast to 405.

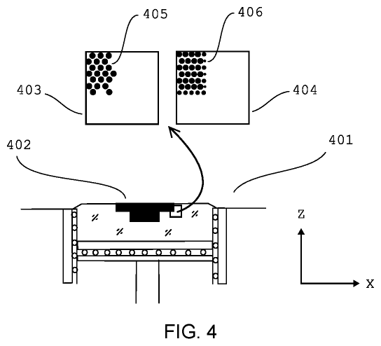

FIG. 5: A conventional prior art process results in interference patterns 503 on the lateral surfaces 502 of the created molded article 501. Said patterns can be minimized, but not eliminated, by elaborate algorithms as described in previously published patent specifications. In additive manufacturing, aliasing effects have a particularly drastic impact on surface quality due to the layer-by-layer construction of a molded article. Due to an offset of the dosing unit in the Y-direction, which is required by the principle, grooving effects occur on the sides of the molded article, resulting in a considerably coarser surface: another disadvantage of the layering technique that is well known among experts. Similar to what is illustrated in FIG. 3, this can also be counteracted by means of variable fluid dosing, resulting in smooth surfaces and giving the molded article an isotropic geometry and surface reproduction.

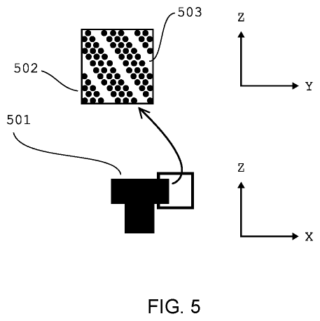

FIG. 6: Variable droplet dosing can be used to define regimes within a continuous molded article in three dimensions, which then result in specific material properties of the created molded article. As an example, the variation of the stiffness in the coating direction (X direction) is shown here at 603. In this special case, increasing the amount of absorber in regime (I) in 601 results in increased stiffness at the corresponding location in the molded article 602. Intermediate stages are possible (III). Regime (II) would have a lower stiffness in this illustration, since less energy is absorbed there due to the lower absorber density per area during exposure by means of the sintering unit, see FIG. 1, which results in lower temperatures and thus a lower degree of melting of the powder granules. In this example, a lower degree of melting means lower strength and a lower hardness of the area, since elements of the powder material can be displaced against each other to a greater extent, in contrast to more molten areas. By means of variable dosing per image dot, this is possible to a finer degree than in the prior art, resulting in an extended range of materials and strengths. Furthermore, the variation in the mechanical properties does not lead to a reduction in resolution due to gaps in the print image, see FIG. 2.

FIG. 7: By means of suitable software, different properties can be defined 704, 705 and 706 within a coherent virtual molded article 701, regimes which, with the aid of gray scale representations in the layer data 702 and the corresponding interpretation, manifest themselves in variations in the droplet volumes 708 of the liquid 709 dosed by the print head 707 in the molded article produced. By way of example, it is shown how a virtual three-dimensional representation with integrated strength definition, represented in the figure by variations in the shading by means of a further dimension, can be used in a process called “slicing” via a software step to provide control data for the so-called gray scale printing of the fluid dosing unit.

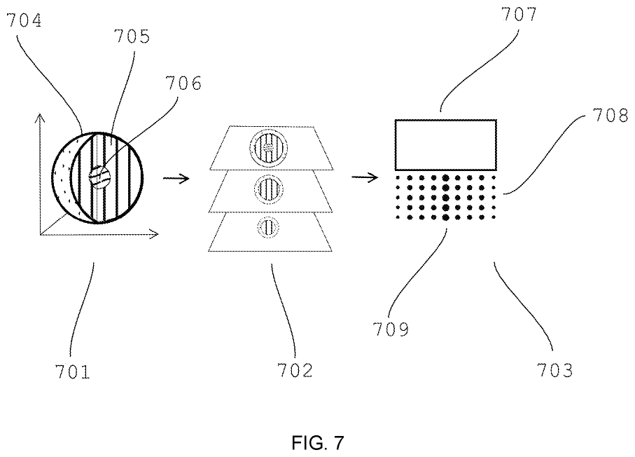

FIG. 8: A mixture of two materials with different melting temperature ranges 804 and 805 is applied as one layer, so that a softer polymer 804 is melted when temperature T1 is reached and polymer 803, which has a higher degree of hardness, is melted 802 upon exceeding a temperature T2, achieved by varying the amount of absorber per image dot 806. A higher absorber amount leads to better energy coupling and thus to a higher temperature in this area 807 and vice versa 808. When using material mixtures, regions of different properties can thus be defined in three dimensions, e.g. a region of greater hardness 811 and a region of lesser hardness 810. The two powders can be mixed at a wide ratio, e.g. 10% to 90%. Here, too, varying the amount of fluid per image dot does not result in any quality disadvantages or problems. The amount of fluid can be applied in a continuous course within the molded article in all three spatial dimensions, which would result in a continuous hardness gradient along this course. Thus, it is possible to continuously adjust the hardness gradient in all spatial dimensions.

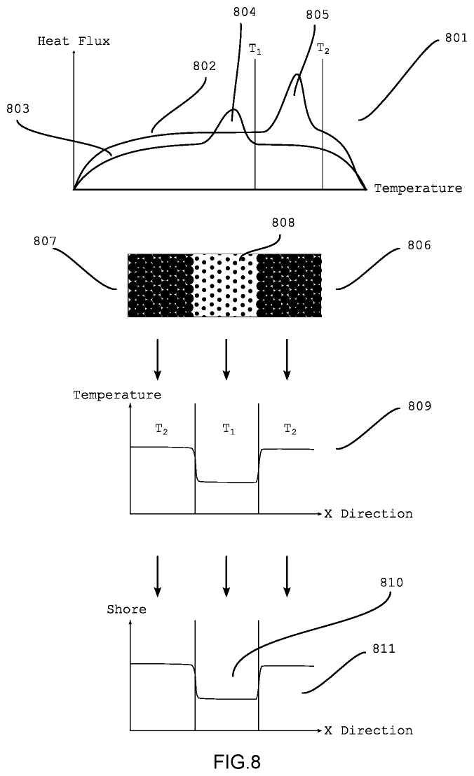

FIG. 9: A second temperature sensor (913), such as a pyrometer, measures the temperature on the sintered surfaces 903 and controls the mass of absorber fluid droplets introduced by the print head (900) in the next layer to be deposited as a function of the measured temperature. In this case, a lower droplet mass achieves a lower temperature and vice versa. This provides an improvement in process stability without reduction in quality and/or involuntary generation of interfering patterns on the molded articles, which is a known disadvantage of the prior art.

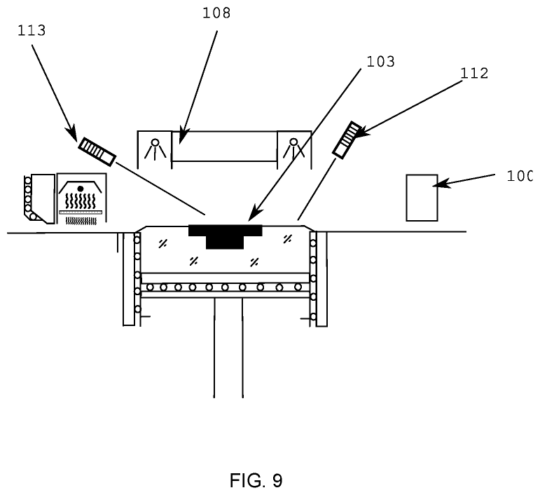

FIG. 10: In the case of bidirectional printing, i.e. printing in the forward and reverse directions, the number as well as the absolute amount of droplets used per image dot can be doubled. With the increase in the number of gradations of the possible absorption factors, a finer gradation of temperature levels during sintering is thus achieved, for example. While in the normal case, for example, 7 gray levels can be imaged, the number of gray levels can thus be doubled, and optionally the amount of dosed fluid can also be doubled.

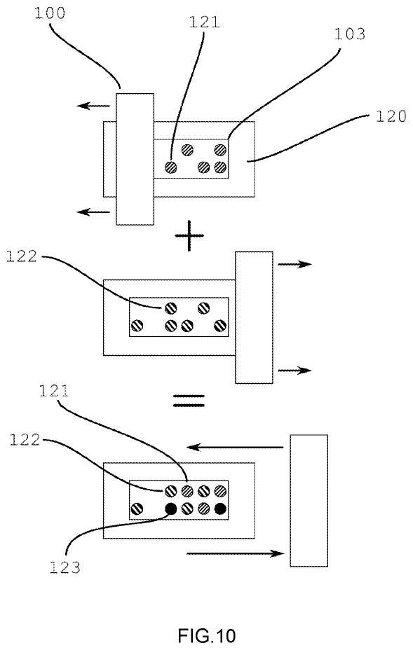

Although various aspects of the disclosure will be described in more detail below, they should not be construed as restrictive.

In one aspect, the object underlying the application is achieved by a method for producing 3D molded parts, wherein one or more particulate construction materials are applied in a defined layer onto a construction field by means of a recoater, one or more absorbers or one or more liquids comprising one or more absorbers are selectively applied as printed image dots by means of a print head, energy is input by means of an energy source, the areas with selectively applied absorber selectively solidifying, the construction field is lowered by one layer thickness or the recoater is raised by one layer thickness, these steps are repeated until the desired 3D molded part is produced, characterized in that the amount of absorber within a layer per printed image dot is set to a predetermined value.

This is achieved, for example, by varying the mass or droplet size of the applied absorber fluid of each image dot to be introduced, instead of or in addition to the process of dithering mentioned above.

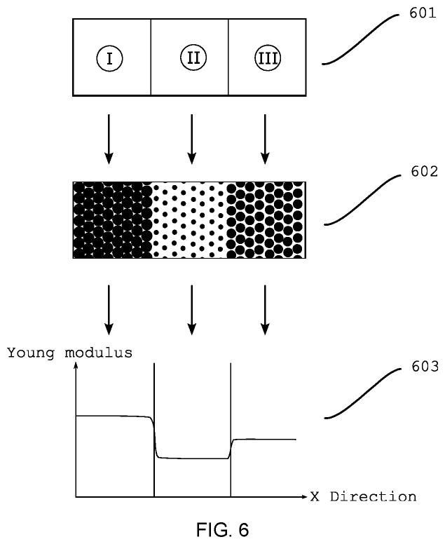

Thus, a contiguous surface of areas of different absorption constants and consequently also resulting varied mechanical variables is created. (FIG. 6)

In one aspect of the disclosure, it is advantageously achieved that a better and more homogeneous distribution of the absorber can be obtained even at low densities without reducing the resolution, thereby eliminating the need for a reflector fluid. Since the application of a second fluid not only doubles the cost of the printing system, but is also a very complex process in terms of space requirements and consumables, there are already advantages to be gained here, just considering the process control, which extend to the operating costs for the end customer. On the one hand, consumables have to be replenished less often, and wear parts on the device have to be replaced less frequently. In particular, the relatively expensive printing technology achieves a longer service life and thus a significant reduction in costs.

Furthermore, an increase in the accuracy of the temperature distribution within a layer can be achieved and this thus allows much more precise control of the process and thus access to a greater variety of processable particulate materials, i.e. the use of construction materials that were previously only poorly processable or difficult to process.

Due to the fine and/or variable variation levels of droplet dosing, it is also possible to obtain transitionless variations in the mechanical variables of the molded articles. For example, improved surface quality can be achieved and e.g. a reduction of roughness and smoother surfaces can be obtained.

With a low dosage setting, white powder adhesion to the created molded articles can be controlled in a specific manner so that the molded articles can be colored more effectively after production.

It is also conceivable to use a mixture of materials as the underlying particulate material, consisting of materials with different melting temperatures, for example. In this case, the materials can be modified in such a way that each absorber grade can be assigned exactly one melting temperature of a particulate material in the mixture.

This makes it possible to create multi-material molded articles without having to accept any loss of quality or speed in the manufacturing process. The use of one or more additional material application systems is also eliminated.

With the method according to the disclosure, it becomes possible to improve the process control of the printing process, such as achieving improved control of energy input, thereby expanding the range of materials accessible for such 3D printing processes, e.g., using thermoplastic polyurethane (TPU).

Further, a method according to the disclosure allows the construction of multi-material systems. Thus, different materials, such as a mixture of different TPU types of different Shore hardness, can be printed in one part and thus, under certain circumstances, the material properties within a part can be varied. Advantageously, a change of the particulate material does not require a change of the printed binder. It is also advantageously possible to differentiate the control of the molded article strength in three dimensions.

Furthermore, stabilization of the printing process can be achieved without loss of quality. Also, with a method according to the disclosure, it becomes possible to achieve specific control of the temperature input, as well as printing of material mixtures with different melting temperatures.

Another advantage of a method according to the disclosure may be an improved skin core, thereby improving, for example, coring capability.

### DETAILED DESCRIPTION OF THE INVENTION

Several terms according to the invention will be explained in more detail below.

A “molded article” or “part” or “molded part” or “3D molded article” or “3D part” or “3D molded part” in the sense of the invention means all three-dimensional objects manufactured using the method according to the invention or/and the device according to the invention and exhibiting dimensional stability.

“Construction space” is the geometric location where the particulate material bed grows during the construction process by repeated coating with particulate material or through which the bed passes when applying continuous principles. The construction space is generally bounded by a bottom, i.e. the construction platform, by walls and an open top surface, i.e. the construction plane. In continuous principles, there usually are a conveyor belt and limiting side walls.

A “construction plane” or construction platform in the sense of the disclosure is the area of a device suitable for 3D printing methods onto which layers of particulate material (fluid) are repeatedly applied, which leads to the construction of a molded article by selective solidification.

The “heating phase” refers to heating of the device at the beginning of the process. The heating phase is complete as soon as the required temperature of the device becomes stationary.

The “cooling phase” in the sense of the disclosure lasts at least until the temperature is so low that the parts are not subject to any significant plastic deformation when removing them from the construction space.

The “particulate materials” or ““fluids” of use herein may be any materials known for powder-based 3D printing methods, in particular polymers, ceramics and metals. The particulate material is preferably a free-flowing powder when dry, but may also be a cohesive, cut-resistant powder or a particle-charged liquid. In this specification, particulate material and powder are used synonymously.

The “particulate material application” in the sense of the disclosure is the process of generating a defined layer of powder. This may be done either on the construction platform or on an inclined plane relative to a conveyor belt in continuous principles. The particulate material application is also referred to herein as “coating” or “recoating”.

“Selective liquid application” in the sense of the invention may be effected after each particulate material application or irregularly, depending on the requirements for the molded article and for optimization of the molded article production, e.g. several times with respect to particulate material application. In this case, a sectional image is printed by the desired article.

The “device” used for carrying out the method in the sense of the disclosure may be any known 3D-printing device which includes the required parts. Common components include recoater, construction field, means for moving the construction field or other parts in continuous processes, dosing devices and heating and irradiating means and other parts which are known to the person skilled in the art and will therefore not be described in detail herein.

The “absorber” in the sense of the disclosure is a medium which can be processed by an inkjet print head or any other device working in a matrix-like manner, which medium enhances the absorption of radiation for local heating of the powder.

“Reflector fluid” is the term used in the disclosure for the antagonist of the absorber which, according to the prior art, is used to prevent particulate materials from sintering.

“Absorption” in the sense of the disclosure refers to the uptake by the powder of thermal energy from radiation. The absorption depends on the type of powder and the wavelength of the radiation.

The “support” as used in the disclosure refers to the medium in which the actual absorber is present. This may be an oil, a solvent or generally a liquid.

“Radiation” in the sense of the disclosure is e.g. thermal radiation, IR radiation, microwave radiation or/and radiation in the visible or UV range. In one embodiment, heat radiation is used, e.g. generated by an IR radiator.

“Radiation-induced heating” as used in the disclosure means irradiation of the construction field by stationary or mobile sources of radiation. The absorber must be optimized for the type of radiation. This is intended to produce differences in heating between “activated” and “non-activated” powder.

“IR heating” as used in the disclosure specifically means irradiation of the construction field by an IR radiator. The radiator may be either static or movable over the construction field by a displacement unit. Using the absorber, the IR heating results in different temperature increases in the construction field.

“Radiation heating” as used in the disclosure generalizes the term IR heating. The absorption of radiation of any wavelength may heat a solid or a liquid.

“Area type” in the sense of the disclosure is an expression used to differentiate between unprinted and printed areas.

An “IR radiator” as used in the disclosure is a source of infrared radiation. Usually, incandescent filaments in quartz or ceramic housings are used to generate the radiation. Depending on the materials used, different wavelengths result for the radiation. In addition, the wavelength of this type of radiator also depends on its power.

A “source of radiation” in the sense of the disclosure generally emits radiation of a specific wavelength or a specific wavelength range. A source of radiation with almost monochromatic radiation is referred to as a “monochromatic radiator”. A source of radiation is also referred to as an “emitter”.

An “overhead radiator” in the sense of the disclosure is a source of radiation mounted above the construction field. It is stationary, but has an adjustable radiant power. It essentially ensures non-selective surface heating.

The “sintering radiator” in the sense of the disclosure is a source of radiation which heats the printed process powder to above its sintering temperature. It may be stationary. In preferred embodiments, however, it is moved over the construction field. In the sense of this invention, the sintering radiator is embodied as a monochromatic radiator.

“Secondary radiator” as defined in the disclosure means a radiator which, by passive heating, becomes itself an active emitter of radiation.

“Sintering” in the sense of the disclosure is the term for the partial coalescence of the particles in the powder. In this system, the build-up of strength is connected with the sintering.

The term “sintering window” as used in the disclosure refers to the difference in temperature between the melting point occurring when first heating the powder and the solidification point during the subsequent cooling.

The “sintering temperature” in the sense of the disclosure is the temperature at which the powder first begins to fuse and bond.

Below the “recrystallization temperature”, as defined in the disclosure, powder once melted solidifies again and shrinks considerably.

The “packing density” in the sense of the disclosure describes the filling of the geometric space by solid matter. It depends on the nature of the particulate material and the application device and is an important initial parameter for the sintering process.

The term “shrinkage” as used in the disclosure refers to the process of geometric shortening of a dimension of a geometric body as a result of a physical process. As an example, the sintering of suboptimally packed powders is a process resulting in shrinkage with respect to the initial volume. Shrinkage can have a direction assigned to it.

“Deformation” in the sense of the disclosure occurs if the body is subject to uneven shrinkage in a physical process. Such deformation may be either reversible or irreversible. Deformation is often related to the global geometry of the part.

“Curling” in the sense of the disclosure refers to an effect resulting from the layer-wise approach of the described invention. This means that layers generated in quick succession are subject to different degrees of shrinkage. Due to physical effects, the compound then deforms in a direction which does not coincide with the direction of shrinkage.

The “gray value” or “gray level” as used in the disclosure refers to the amount of an absorber introduced into the powder per area element. According to the invention, different gray values can be generated on the particulate material surface within one wetting step in order to achieve areas of different temperatures, due to the changed energy coupling, during radiation heating by means of the sintering radiator. For each “gray level”, a defined droplet dosing quantity from the total selection available can be imprinted in the particulate material.

“Printed image dot” as used in the disclosure means the dot printed into the particulate material by means of a print head or any means usable in a comparable manner. The “printed image dot” can vary in different parameters. For example, a “printed image dot” can be set to a predetermined gray level, preferably the gray levels can be set continuously. This is in contrast to a step function as known from the prior art; in this case only the pixel points/number of image dots per area are varied. The printed image dot as such is substantially not modified in its properties. Also, each “printed image dot” can be adjusted in its diameter in the X and Y axes, or in its volume in the X, Y and Z directions. Also, in each “printed image dot” a black area can be set to between 1% and 100% in terms of the percentage of absorber per area or per volume.

A “black area” as defined in the disclosure is to be understood as the amount of particulate material per unit area or per unit volume; thus, the “black area” indicates a value or measure of the amount of absorber.

An “edge region” in the sense of the disclosure refers to the region of a 3D printed component or molding that, among other things, forms the surface. Thus, the structure of the “edge region” is also responsible for how smooth or uneven the surface of the 3D molded part is. In the prior art, the degree of smoothness of the surface is determined by the pixel size and how the pixels are arranged on a surface, i.e. in the edge region, and to what extent they form steps in a curvature region and how pronounced these steps are. An “edge region” within the meaning of the disclosure may be designed using printed image dots such that there are essentially no steps or minimally pronounced steps. As a positive effect, a very smooth surface and a very smooth edge region can thus be achieved.

A “post-processing step” in the sense of the disclosure is the further treatment of the 3D molded part obtained in the 3D printing process, e.g., by means of anti-aliasing or in a finishing booth.

“Anti-aliasing” as used in the disclosure is a term borrowed from the field of computer graphics and essentially describes edge smoothing synonymously there. When screening of a graphic causes staircase effects in the resulting graphic, these are eliminated by calculating intermediate values between two neighboring pixels using a special algorithm.

A “finishing booth” in the sense of the disclosure is an apparatus which is applied to the molded article in the process step after creation of the molded article to remove residual material and adhesions. According to the prior art, a blasting medium, e.g. consisting of fine glass beads, is often used, directing said beads onto the object by means of compressed air. This step can be done manually or in an automated manner with predefined parameters.

“Filter” or “filtering” in the sense of the disclosure means a masking out of parts of an electromagnetic radiation spectrum, where the desired electromagnetic radiation spectrum hits a target surface, e.g. a construction field surface.

“Temperature window” or “temperature range” in the sense of the disclosure means a defined temperature range below or within the sintering range of the particulate material used.

“Basic temperature” in the sense of the disclosure means the temperature to which the particulate material is heated and which is lower than the melting temperature and/or the sintering temperature.

“Dithering,” as used in the disclosure, refers to a possible type of algorithm used in imaging techniques for screening with reduced color depth. By selectively arranging pixels, a higher color depth is reproduced at the expense of the level of detail. Dithering is used synonymously with halftoning in the description of the invention and the description of the prior art.

“Absorber density” in the sense of the disclosure is a defined degree of wetting of the surface of the particulate material with absorber.

“Absorber density” as used in the disclosure means the amount of absorber per area applied to the particulate material.

“Absorber density range” as used in the disclosure means the range of minimum and maximum surface wetting degrees by an absorber along the X and Y axes.

“Absorber amount” in the sense of the disclosure means the quantity of absorber deposited by the dosing device per printed image dot.

“Energy coupling” as used in the disclosure means the effectiveness of the percentage of electromagnetic radiation received relative to the reflected radiation.

Further details of the disclosure are described below.

In one aspect, the object underlying the application is achieved by a method for producing 3D molded parts, wherein one or more particulate construction materials are applied in a defined layer onto a construction field by means of a recoater, one or more absorbers or one or more liquids comprising one or more absorbers are selectively applied as printed image dots by means of a print head, energy is input by means of an energy source, the areas with selectively applied absorber selectively solidifying, the construction field is lowered by one layer thickness or the recoater is raised by one layer thickness, these steps are repeated until the desired 3D molded part is produced, characterized in that the amount of absorber within a layer per printed image dot is set to a predetermined value, and wherein different predetermined values can be set in two or more image dots within a layer.

A method according to the disclosure achieves multiple advantages over known prior art methods. In contrast to known processes, various parameters can be varied for each printed image dot, thus improving the quality of the molded part produced on the one hand. On the other hand, the method according to the disclosure enables application of the method in areas that were not previously possible. For example, the image sharpness of the manufactured parts is improved in that the edge regions can be imaged more accurately with respect to the data and edge sharpness can be increased. On the other hand, different material properties can now be varied in a part at different points or areas in the part with regard to e.g. elasticity, which was not possible in the prior art. Furthermore, material combinations can now be used that could not previously be combined in this way.

In another aspect of the disclosure, a method as described above is provided wherein the volume of absorber or one or more liquids comprising one or more absorbers per printed image dot or/and the concentration of absorber or one or more liquids comprising one or more absorbers per printed image dot or/and the size of the printed image dots are set to a predetermined value and wherein different predetermined values can be set in two or more image dots within a layer.

Thus, the absorber can be adapted very specifically per printed image dot to the respective printing needs and the desired material properties in the printed part and can be adjusted very differentially. In particular, in a method as described herein, the amount of imprinted absorber per area element of the printed image dots or/and per volume element of the printed image dots can be set to a predetermined value, preferably wherein the area element is 0.0001 to 0.08 mm² or 1-5 mm² to 4000 cm² or 50 mm² to 40 cm², or/and wherein the volume element is 0.000001 to 0.04 mm³ or 5 mm³ to 10 cm³ or the area element or/and volume element corresponds to the 3D molded part, e.g. in a sectional view, and/or the amount of imprinted absorber per printed image dot is between 1 ng and 2 g, preferably 3 ng to 500 ng, more preferably 5 ng to 300 ng.

This advantageously makes it possible to vary the gray level in a printed image dot and thus also to vary it over the entire part in different areas or different printed image dots. In doing so, each printed image dot is set to a predetermined gray level, preferably the gray levels can be adjusted continuously.

In this way, the black area can also be set differently per printed image dot in the disclosed method and, likewise, control in the part to be printed can be determined in a three-dimensional manner with regard to the properties to be achieved in the part. For example, the black area in each printed image dot can be set to a black range between 1% and 100%.

It is possible to put the various parameters, which can be differentiated with the method disclosed here, in relation to different reference values. For example, in the disclosed method, the printed image dots in an area element or/and volume element can be related to the printed 3D molded part and have a proportion of 10% to 95%.

In a method according to the disclosure, advantageous results can be achieved in particular in the edge regions of the parts. For this purpose, the process can be set in such a way that the printed image dots in the edge region of the 3D molded part to be produced have a smaller diameter or/and a smaller volume compared to the other printed image dots, preferably an anti-aliasing is additionally carried out or/and a post-processing step is additionally carried out, preferably in a finishing booth, particularly preferably in an automated finishing booth. This achieves particularly advantageous results in terms of the form sharpness in the part.

Further, with a method according to the disclosure, the number of printed image dots per area or unit area may be increased or decreased, or the number of printed image dots per area or unit area may not be changed during the method.

In a method according to the disclosure, a print head may be used in which the outlet volume is set to a predetermined changeable value. Any print head compatible with the other process parameters and process components can be used in this case. For example, a piezoelectric print head can be used as the print head.

It is conceivable to use any particulate materials that are also compatible with the other process components and materials. In the method according to the disclosure, for example, polyamides, preferably PA12, PA11, PA613, PA6.6, polyether block amides, polypropylenes, thermoplastic polyurethanes, polyethylenes, polycarbonates, polyaryletherketones, polyoxymethylenes or polymethyl methacrylates, a mixture of two particulate materials of different melting temperatures or melting temperature ranges, e.g. between 90° C. and 350° C., more preferably 110° C. to 220° C., a mixture of thermoplastic polyurethanes with different hardness, e.g. between Shore A 60 and Shore D 90, polybutylene terephthalates, mixtures of polybutylene terephthalates e.g. with a bending strength between 40-250 MPa, or mixtures of one or more of the above materials, can be used as particulate materials.

In the method disclosed herein, common absorbers known to the person skilled in the art are used, and carbon particles can be used as absorbers. Examples include the products Black Oil-based Ink IK82104 from Xaar plc and HiRes Oil Black LMOPI11AKK from Nazdar Ltd.

In a method according to the disclosure, any source of energy or radiation can be used for solidification, which is set and adjusted according to the further process parameters. An emitter of electromagnetic radiation in the infrared range, e.g. in the near infrared range, or in the visible range can be used as the energy source.

The layer thickness of the applied particulate material can be selected to be constant or variable, and the layer thickness can be set from 5 to 500 micrometers. A layer thickness of 10 to 300 or 5 to 30 micrometers is in the range of the usual and advantageous layer thickness.

It has been shown to be advantageous that in a method according to the disclosure, the printed image dots can be varied in their characteristics and thus desired or/and advantageous properties can be achieved in the printed parts. For example, a printed image dot can be set to a diameter of between 10 and 140 micrometers, or a resolution of 90 or 1200 dpi can be selected.

A printed image dot and the printed image dots adjacent to each other and those forming an edge region may also be adjusted in volume to a predetermined volume value in a method according to the disclosure. For example, in a method according to the disclosure, a printed image dot can be set to a volume of between 1.5 and 100 picoliters.

Similarly, the absorber concentration in a printed image dot can be selected as desired. In a method according to the disclosure, the absorber concentration can be set to between 1% and 20%.

Furthermore, the time interval between the printed image dots can have an influence on the characteristics of the area of the solidified printed image dots. The time interval between different printed image dots can also influence the characteristics of the area in which different or/and several printed image dots are located. In a method according to the disclosure, the time interval between the printing of an image dot and energy input can be set to between 10 and 1000 milliseconds.

The above described parameters, i.e. 2- or 3-dimensional measurements such as the diameter etc. of a printed image dot, volume input into a printed image dot, distance of the printed image dots from each other, the distance of the printed image dots along the Z and/or X axis or/and along the Y axis, the time interval for the printing of printed image dots can be combined individually. Thus, the characteristics of the printed part itself as well as in any desired area of the part can be selected in terms of elasticity, dimensional stability, Shore hardness, material composition, edge properties, properties in the edge region of the part.

Further aspects of the disclosure will be described below.

According to the disclosure, the object underlying the application is also achieved in various aspects by a method for producing 3D molded parts, wherein one or more particulate construction materials are applied in a defined layer onto a construction field by means of a recoater, one or more liquids or one or more particulate materials of one or more absorbers are selectively applied, an energy input is effected by means of a radiator, the areas with selectively applied absorber selectively solidifying, the construction field is lowered by one layer thickness or the recoater is raised by one layer thickness, these steps are repeated until the desired 3D molded part is produced, characterized in that the method varies the absorber density within a layer per printed image dot by means of the dosed volume of image liquid or/and absorber, the dosed concentration of absorber, the printed image dots per unit area or volume, the distance between the printed image dots.

The disclosure provides a method in which, advantageously, the temperature windows of the recurring process steps can also be adjusted more precisely. This in turn results in further significant improvements in procedure, product quality, the recycling rate of materials, ecological advantages and cost benefits.

Furthermore, in a method according to the disclosure, the procedure is more gentle on the machines used and the parts present in them. The heat generation may also be lower in some cases and it may also become more precisely controllable. This also makes the method more energy-efficient.

Furthermore, in a method according to the disclosure a solution is provided to specifically influence material properties of the produced molded article in three dimensions. In the production of the molded articles in a method according to the disclosure they are thus not only given their three-dimensional shape, but properties of a mechanical nature are also added to them in three dimensions. This can be mechanical strength and/or elasticity, as well as material density and thus weight and/or center of gravity. These properties, which are not apparent from the outside in the appearance and/or surface or shape of the body, can be used specifically for weight reduction, or for the creation of centrifugal masses with a shifted center of mass.

In a method according to the disclosure one or more print heads can be used which are gray scale capable according to the prior art and in which the dosed droplets can thus be controlled in volume.

Furthermore, in a method according to the disclosure the changes in the droplet volumes can be used specifically to optimize the energy absorption of the radiation for the heating phase or/and the sintering phase and thus achieve improved temperature windows at the material layer itself on the construction field.

Any material that is compatible with the process parameters can be used and applied in a method according to the disclosure. For example, a polyamide powder, a polyamide-based thermoplastic elastomer or a urethane-based thermoplastic elastomer can be used as the powder material. Also possible are materials based on polypropylene and polyethylene, as well as polymers with ester functions. The range of the dosed absorber amount and the temperature windows can then be adapted accordingly in order to achieve an advantageous procedure and advantages for the product parameters and recycling rate, among other things.

Furthermore, any absorber fluid compatible with a method according to the disclosure may be used. This includes not only oil-based but also, for example, water- and solvent-based fluid systems, as well as various color pigments contained therein. In particular, colorations of the fluid can be used which have adjusted absorption maxima in the infrared and/or visible or ultraviolet range.

For example, a method according to the disclosure is characterized in that the applied powder layer is heated in a first heating step to a basic temperature of the powder without the absorber, which is within the sintering window of the powder material, and a second sintering step leads to selective solidification, by heat input, of the areas printed with absorber, at a sintering temperature above the melting temperature of the powder, wherein the areas with the selectively applied absorber heat up more in the first step than the areas without absorber, and thus a temperature difference is set between areas with and without absorber.

Furthermore, according to the disclosure, the object underlying the application is achieved by a device suitable for producing 3D molded parts, said device comprising all the components necessary for a powder-based printing process, characterized in that it comprises at least one print head which is capable of varying the dosed material volume within one pass per image dot.

A device which is suitable for a method according to the disclosure achieves in an advantageous way that disadvantages of known devices and methods are reduced or can substantially be avoided.

With a device according to the disclosure it is possible to move the temperature windows into more defined areas and thus achieve more optimal temperature ranges with regard to the materials used. This offers further advantages in terms of the quality of intermediates and products. Furthermore, the recycling rate of the powder material can thus be increased, allowing to achieve i.a. a reduction in costs and thereby lower production costs.

In addition, both edge sharpness and surface quality of the molded articles produced by means of the method or device according to the disclosure can be significantly improved.

For example, for droplet dosing of an absorber, a print head can be used which is able to vary the fluid volume per single dosing.

A device according to the disclosure is characterized, for example, by a grayscale-capable print head having at least one print module capable of depositing droplet volumes of variable size per image dot.

Furthermore, all dosing devices can be used which are suitable for varying the fluid dosing per deposited image dot as desired. For example, the print head is grayscale-capable.

In one aspect of the disclosure, it is possible for the selected droplet volume range to be between 6 and 30 picoliters per printed image dot at a dot density of 360 dpi.

In a device according to the disclosure one or more fluid dosing devices may be arranged in any suitable manner. It may be advantageous if at least two gray-scale capable print modules are arranged in a substantially staggered manner, preferably resulting in an overlap between the modules. This allows more specific control of the droplet volumes per printed image dot, in turn allowing the commercial seven-fold gradation to be almost doubled.

A device according to the disclosure has all parts necessary and known for a high-speed sintering process, which therefore need not be described in detail here. Parts suitable for a method according to the disclosure are components selected from the construction platform, side walls, job box, recoater, print head, ceramic sheet, energy input means, preferably at least one radiator, preferably an overhead radiator or/and a sintering radiator unit.

As explained above, an essential aspect of the present disclosure is to control the absorber amount or the temperature windows of the method and to carry out the method according to the disclosure in defined areas. The aim can also be to control the properties of parts with pinpoint accuracy per printed image dot by means of absorber dosing. Differences and variations in three-dimensional strength zones can thus be represented substantially without loss of quality.

It is therefore advantageous to use a piezoelectric print head in which the absorber fluid volume per printed image dot is controlled via the gray value of a digitally available bitmap. Light image areas correspond to the dosage of e.g. low droplet volumes, dark image areas to a higher droplet volume.

An example of products available on the market is the Xaar 1003 GS6 print head, which can cover a droplet mass range of 6-42 pl per printed image dot at a print density of 360 dpi with a maximum of 7 gray levels. Another option is the product RC1536-M or RC1536-L from Seiko Instruments GmbH, which can achieve a droplet mass of 13-100 pl with a gradation of up to 14 gray levels and otherwise identical specifications.

Furthermore, it can be advantageous to link the variable droplet dosing with screening, e.g. dithering. Thus, the absorption coefficient, the energy coupling and, accordingly, the effective temperature of the particulate material to be solidified can be adjusted even more finely.

Furthermore, this allows a wider range of droplet volumes to be covered. For example, a checkerboard pattern of printed image dots of the lowest possible intensity can be created, further lowering the effective absorber density averaged over the area. For example, in the case of particulate materials consisting of semi-crystalline, non-polar polyolefins, it may be advantageous to lower the absorber density to 3 picoliters per dot, as this enables higher mechanical variables to be achieved in the molded articles produced.

Furthermore, in a method according to the disclosure, the ratio of area or volume printed with printed image dots to unprinted area or volume can also be adjusted with respect to an area or volume. Thus, the area or volume printed with printed image dots is put in a ratio with the unprinted area or volume. This allows the material properties in the manufactured molded part to be adjusted very precisely.

An adjustment of the parameters in the printed image dots allows a selection of certain parameters in the manufactured part not only within a molded part, but it is also possible to advantageously adjust the distance and, for example, the sharpness of separation between the parts using the method according to the disclosure.

In order to maximize the material properties of any material that can be processed in the HIGH SPEED SINTERING printing process, optimization of the absorption coefficient of the surface to be sintered must be adapted. This is done by varying the droplet mass of the amount of absorber fluid applied to the powder surface. According to the prior art, changing the printing material in a high-speed sintering machine therefore requires adjustments to the hardware. By means of the possibility of direct manipulation of the absorber amount via setting gray level information, this is now possible via software, e.g. via job data information at the process program call.

Examples of such adjustments include the software setting of 24 pl per printed image dot for polyamidel2 materials, 6 pl for polypropylene, or 3 pl for thermoplastic polyurethane.

The various features of the different aspects described above can each be combined with each other even if this has not been explicitly stated for each feature.

### LIST OF REFERENCE NUMERALS

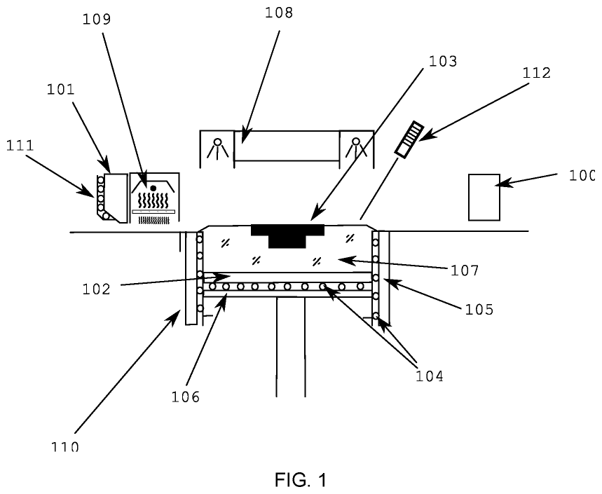

100 Print head
101 Recoater with powder reservoir
102 Bottom of the construction container
103 Molded article
104 Heating on the walls and floor of the construction container
105 Lateral insulation of the construction container
106 Insulation of the bottom of the construction container
107 Particulate material cake
108 Emitter of electromagnetic radiation directed onto the construction field surface, controlled and/or regulated
109 Emitter of electromagnetic radiation of a wavelength ensemble differing from 108, directed onto the construction field surface, movable over the construction field surface, controlled and/or regulated
110 Construction platform for producing the molded article
111 Powder reservoir on the recoater
112 Pyrometer on unprinted powder
113 Pyrometer on sintered powder
201 Variation of the applied amount of fluid per area according to the method of screening or dithering
202 Variation of the applied amount of fluid per area according to the method of true gray levels: variation of the volume of every single droplet
203 Gap pattern resulting from masking out image dots to achieve lower absorber volume averaged over area
204 No gap pattern when absorber volume per area is reduced because of direct adjustment of droplet volumes. Symbolic representation.
205 Small absorber volumes per area lead to large gaps between areas with absorber and areas without absorber, according to the conventional method.
206 Even with small amounts of absorber per area, there are no large gaps.
301 Top view of layer of particulate material
302 Area wetted with absorber fluid
303 Transition wetted to unwetted area in magnification in representation of the process of screening
304 In comparison, enlarged representation when using the method of varying the dosage of individual droplet volumes
305 Gap caused by screening at a corner of wetted to unwetted area
306 When varying the dosage, the sharpness of separation between the wetted and the unwetted area at the corner is maintained
401 Example of a device for producing the molded article
402 Already produced molded article, embedded in loose particulate material
403 Detailed view of the corner of the molded article, produced by dosing according to conventional methods of screening
404 Detailed view of the corner of the molded article, produced by dosing according to the method of adapting the volume of every single droplet
405 Gaps in the edges of the molded article
406 Gapless, straight structure
501 Molded article produced using the device in FIG. 1
502 Lateral detailed view of the produced molded article
503 Interference pattern caused by conventional method on one side of the molded article
601 Definition of different regimes within a contiguous molded article in the input data of the layer data provided to the device.
602 Regions of different dosing quantities defined by regimes when wetting the surfaces of the particulate material during layer-by-layer creation of the molded article.
603 Solidification during sintering causes areas of different elasticity to form as a result of the change in the absorptivity of the particulate material surface during layer-by-layer creation of the molded article
701 Virtual representation of the molded article. Different regimes can be defined in three dimensions, each with different virtual properties.
702 By means of a suitable image processor, layer data of the virtual molded article is created according to the assigned virtual properties, with the sectional planes through regimes of different properties corresponding to a variation in the gray levels of the layer data.
703 The different gray levels of the individual layer data of the molded article to be created are interpreted in the print head control technology as variations in the droplet volumes deposited by the print head.
704 Virtual representation of the molded article to be created
705 Exemplary definition of an arbitrary regime within the molded article
706 Exemplary definition of a second arbitrary regime within the first molded article
707 Print head
708 Dosage of a quantity of liquid per image dot
709 Variation in dosing quantity corresponding to defined regime in 706
801 Schematic representation of the melting curves of two different polymers
802 Melting curve of the first polymer
803 Melting curve of the second polymer
804 Melting peak of the second polymer, ending with temperature T1
805 Melting peak of the first polymer, ending with temperature T2
806 Area of different absorber input in the particulate material
807 Increased absorber amount
808 Decreased absorber amount
809 Variation in the amount of absorber per image dot leads to different temperatures when the solidification process is carried out. In this case, regions of temperature T2 correspond to the higher absorber density and regions of temperature T1 correspond to the lower absorber density.
810 Area in which only polymer 2 was melted is softer
811 Area in which both polmyers were melted is softer
900 Print head
903 Molded article with sintered surface
908 Emitter of electromagnetic radiation directed onto the construction field surface, controlled and/or regulated
912 Pyrometer on unprinted powder
913 Pyrometer on sintered powder
1000 Print head
1003 Surface of the molded article to be created
1020 Surface of the particulate material
1021 Droplet applied in the first step with variable mass per image dot
1022 In the second step, which runs in the opposite direction to the first, the mass of the droplets is again variable per image dot
1023 Result in overlaps: double droplet mass per image dot possible in combinations

What is claimed is:

1. A method for producing 3D molded parts, wherein one or more particulate construction materials are applied in a defined layer onto a construction field by means of a recoater, one or more absorbers or one or more liquids comprising one or more absorbers are selectively applied as printed image dots by means of a print head, energy is input by means of an energy source, the areas with selectively applied absorber selectively solidifying, the construction field is lowered by one layer thickness or the recoater is raised by one layer thickness, these steps are repeated until the desired 3D molded part is produced, characterized in that an amount of the one or more absorbers within a layer per printed image dot is set to a predetermined value and wherein different predetermined values can be set in two or more of the image dots within a layer.

2. The method according to claim 1, wherein a volume of absorber or one or more liquids comprising the one or more absorbers per printed image dot or/and a concentration of absorber or one or more liquids comprising the one or more absorbers per printed image dot or/and a size of the printed image dots are set to a predetermined value.

3. The method according to claim 1, wherein the amount of imprinted absorber per area element of the printed image dots or/and per volume element of the printed image dots is set to a predetermined value, preferably wherein the area element is 0.0001 to 0.08 mm² or 1-5 mm² to 4000 cm² or 50 mm² to 40 cm², or/and wherein the volume element is 0.000001 to 0.04 mm³ or 5 mm³ to 10 cm³ or the area element or/and volume element corresponds to the 3D molded part, e.g. in a sectional view, and/or the amount of imprinted absorber per printed image dot is between 1 ng and 2 g, preferably 3 ng to 500 ng, more preferably 5 ng to 300 ng.

4. The method according to claim 3, wherein each printed image dot is set to a predetermined gray level, preferably the gray levels can be set continuously, preferably
wherein each printed image dot is set to a black range between 1% and 100%, or/and
wherein the printed image dots in an area element or/and volume element are related to the printed 3D molded part and have a proportion of 10% to 95%.

5. The method according to claim 1, wherein the printed image dots in the edge region of the 3D molded part to be produced have a smaller diameter or/and a smaller volume compared to the other printed image dots.

6. The method according to claim 1, any one of claims 1 to 5, wherein the number of printed image dots per area or unit area is increased or decreased.

7. The method according to claim 1, wherein the particulate material includes a polyamide (preferably PA12, PA11, PA613, or PA6.6), a polyether block amide, a polypropylene, a thermoplastic polyurethane, a mixture of two particulate materials of different melting temperatures or melting temperature ranges (preferably between 90° C. and 350° C., more preferably 110° C. to 220° C.), a mixture of thermoplastic polyurethanes with different hardness (preferably between Shore A 60 and Shore D 90) a polybutylene terephthalate, mixtures of polybutylene terephthalates with a bending strength between 40-250 MPa, a polyethylene, a polycarbonate, a polyaryletherketone, a polyoxymethylene, a polymethyl methacrylates, or a mixture of one or more of the above materials.

8. The method according to claim 1, wherein the one or more absorbers are carbon particles, or/and
wherein the energy source is an emitter, preferably of electromagnetic radiation in the infrared range or in the visible range.

9. The method according to claim 1, wherein the layer thickness is set to 10 to 300 micrometers, or/and
wherein a printed image dot is set to a diameter of between 10 and 140.

10. The method according to claim 1, wherein a printed image dot is set to a volume of between 1.5 and 100 picoliters, or/and
wherein the absorber concentration is set to between 1% and 20%, or/and
wherein the time interval between the printing of an image dot and energy input is set to between 10 and 1000 milliseconds.

11. The method of claim 1, wherein within a layer, a first image dot and a second image dot are printed with different amounts of the one or more absorbers.

12. The method of claim 3, wherein the area element is 0.0001 to 0.08 mm², or/and wherein the volume element is 0.000001 to 0.04 mm³ or 5 mm³ to 10 cm³, or/and the amount of imprinted absorber per printed image dot is between 1 ng and 2 g.

13. The method of claim 3, wherein the area element is 50 mm² to 40 cm², the volume element is 0.000001 to 0.04 mm³ or 5 mm³ to 10 cm³, and the amount of imprinted absorber per printed image dot is 5 ng to 300 ng.

14. The method of claim 4, wherein the gray levels can be set continuously, wherein each printed image dot is set to a black range between 1% and 100%.

15. The method of claim 14, wherein the printed image dots in an area element or/and volume element are related to the printed 3D molded part and have a proportion of 10% to 95%.

16. The method of claim 5, wherein an anti-aliasing is additionally carried out and a post-processing step is carried out in an automated finishing booth.

17. The method of claim 1, wherein a print head is used in which the outlet volume is set to a predetermined changeable value, optionally wherein the print head is a piezoelectric print head.

18. The method according to claim 17 wherein the particulate material includes a polyamide, a polyether block amide, a polypropylene, a thermoplastic polyurethane, a mixture of two particulate materials of different melting temperatures or melting temperature ranges, a mixture of thermoplastic polyurethanes with different hardness, a polybutylene terephthalate, mixtures of polybutylene terephthalates with a bending strength between 40-250 MPa, a polyethylene, a polycarbonate, a polyaryletherketone, a polyoxymethylene, a polymethyl methacrylates, or a mixture of one or more of the above materials;
the one or more absorbers are carbon particles;
the energy source is an emitter of electromagnetic radiation in the infrared range or in the visible range;
the layer thickness is set to 10 to 300 micrometers; and
a printed image dot is set to a diameter of between 10 and 140.

19. The method according to claim 18,
wherein a printed image dot is set to a volume of between 1.5 and 100 picoliters;
the absorber concentration is set to between 1% and 20%;
a time interval between the printing of an image dot and energy input is set to between 10 and 1000 milliseconds.

20. The method of claim 19, wherein
within a layer, a first image dot and a second image dot are printed with different amounts of the one or more absorbers;
the amount of imprinted absorber per area element of the printed image dots and per volume element of the printed image dots is set to a predetermined value, wherein the area element is 50 mm² to 40 cm², the volume element is 0.000001 to 0.04 mm³ or 5 mm³ to 10 cm³, and the amount of imprinted absorber per printed image dot is 5 ng to 300 ng;
gray levels can be set continuously, wherein each printed image dot is set to a black range between 1% and 100%; and
wherein the printed image dots in an area element or/and volume element are related to the printed 3D molded part and have a proportion of 10% to 95%.
